(19) United States
(12) Patent Application Publication
(10) Pub. No.: US 2012/0053718 A1
(43) Pub. Date: Mar. 1, 2012

(54) CONTROL DEVICE FOR AN INJECTION MOLDING MACHINE

(75) Inventor: Günther Grimm, Hilgertshausen (DE)

(73) Assignee: KraussMaffei Technologies GmbH, München (DE)

(21) Appl. No.: 13/318,908

(22) PCT Filed: Apr. 29, 2010
(86) PCT No.: PCT/EP10/55818

§ 371 Date: Nov. 4, 2011

(30) Foreign Application Priority Data
May 7, 2009 (DE) 10 2009 020 193.9

(51) Int. Cl. B29C 45/74

(52) U.S. Cl. 700/103

(57) ABSTRACT

In order to be able to freely define or program in a simple way a certain temperature profile which is exactly adjusted to each injection molding cycle in terms of time and run the same in a cycle-synchronized manner, according to the invention a control device for an injection molding machine is provided, in which several events and/or states which are specific to an injection molding cycle and occur during the injection molding cycle, as well as several types of temperature changes are stored and available to a user for selection. The user can select events and/or states as well as types of temperature changes, associate said events and/or states and types of temperature changes with each other, and form a series from several such associations. The events and/or states occurring successively during the injection molding cycle over the course of time as well as the types of temperature changes associated with said events and/or states result in a temporal curve of the temperature. The invention further relates to an injection molding machine comprising such a control device and a temperature control device, which can be used to control the temperature of injection molding tools or regions of injection molding tools.

The injection molding tools used in an injection molding machine are frequently kept at a constant temperature so as to enable fast cooling of the molded part. However, there is an increasing demand initially to briefly heat the injection molding tool before injection, for example to the temperature of the plastic melt, and to cool down to the de-molding temperature only after injection. This situation is referred to as dynamic or vario-thermal temperature control. This technique of the dynamic temperature control of injection molding tools is known since several years (Menges/Michaeli/Mohren: “Anleitung zum Bau von Spritzgieβwerkzeugen” (Manual for the construction of injection molding tools), 5 edition, Hanser-Verlag, 1999, Chapter 8.7.4 “Dynamische Werkzeugtemperierung” (Dynamic tool temperature control)). In the article “Variotherme Temperierung—Methoden und Einsatzmöglichkeiten” (Vario-thermal temperature control—Methods and Applications) by J. Giesslauf, ENGEL Austria GmbH, VDI Technical Meeting “Injection Molding 2008—Innovation and Productivity” of 29.-30. January 2008 in Baden-Baden, Germany, several different methods for vario-thermal temperature control of injection molding tools and their potential applications are presented.

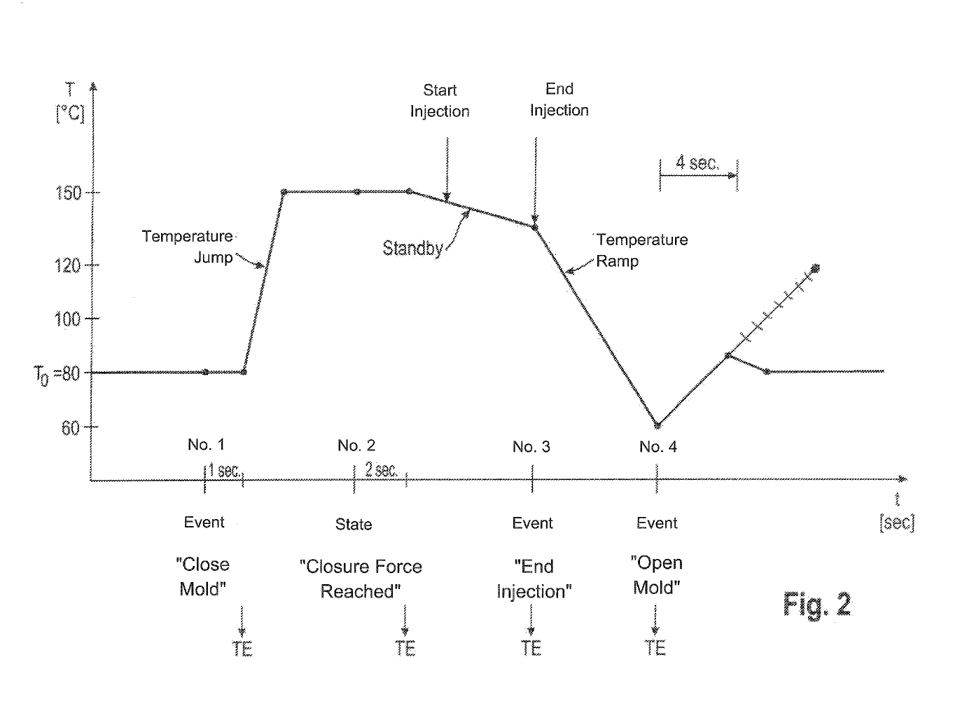

The documents DE 10 2007 019 389 A1, WO 97/16274 A1 and U.S. Pat. No. 5,376,317 A disclose temperature control devices for dynamic and vario-thermal temperature control of injection molding tools operating with two separate temperature control circuits, namely a first temperature control circuit with a fluid at a first temperature (for example relatively hot water or oil) and a second temperature control circuit with a fluid at a second temperature (for example relatively cold water or oil). A control device switches back and forth between the two temperature control circuits at predetermined times. These times can be defined by certain events or states that occur during the injection molding cycle, for example by the event “mold open” or the state “maximum pressure in cavity reached” (see, for example, U.S. Pat. No. 5,376,317 A, column 11, lines 18-52). An injection molding tool can thus be first heated and subsequently cooled down with this temperature control device in each injection molding cycle. The injection molding tool can hereby attained a temperature profile, such as illustrated for example in FIG. 2a of the U.S. Pat. No. 5,376,317 A. A programmable logic controller (PLC) for temperature control is disclosed in DE 10 2007 019 389 A1, wherein data acquired from sensors, for example temperature sensors, are processed by these SPS and control signals are outputted to certain parts of the temperature control device. Signals for the switchover times between the colder and warmer medium depending on the process can be provided by the machine control via programmable inputs and/or outputs.

The times where the temperatures in the injection molding tool are supposed to change, for example when a switchover occurs from heating to cooling and vice versa, are fixedly defined or fixedly programmed in the conventional injection molding machines and temperature control devices, typically in a programmable logic controller (PLC). This is the case even if these times are defined by certain events or states determined during the injection molding cycle, as disclosed for example in the aforementioned U.S. Pat. No. 5,376,317 A. Only actual temperature values, which should be approached with the temperature control device by heating and/or cooling (desired temperatures), can be inputted into a control device by an operator. Accordingly, a desired temperature profile can only be determined or adjusted by an operator in a limited way. A user or operator of an injection molding machine has therefore limited possibilities to affect the course of temperature in the injection molding tool. To change the time dependence of the desired temperature profile, the PLC must be reprogrammed, which a user or operator of an injection molding machine is typically unable to do. This means that appropriately trained personnel must be called, which is associated with a certain time and cost factor.

Based on the aforementioned state-of-the-art, it is the object of the invention to provide a control device for an injection molding machine, whereby an operator of the injection molding machine can easily set up a certain desired value temperature profile (cycle-synchronous desired value temperature profile) which is, in particular, temporally exactly matched to each injection molding cycle.

The object is attained by a control device having the features of claim 1. Advantageous improvements and embodiments are recited in the dependent claims.

In that the control device is constructed such
that several events and/or states which are specific for an injection molding cycle and which occur during the injection molding cycle are stored or can be stored in the control device,
that these events and/or states are each provided as a start condition for controlling one or more temperature control devices for temperature control of an injection molding tool,
that these events and/or states are available to an operator for selecting events and/or certain states,
that several types of temperature changes are stored or can be stored in the control device,
that these types of temperature changes are available to the operator for selecting certain types of temperature changes,
that, on one hand, certain events and/or certain states and, on the other hand, certain types of temperature changes can be selected by the operator and associated with one another,
that a sequence of several events and/or states, on one hand, and types of temperature changes, on the other hand, can be formed,
that a temporal course of a temperature in a region of an injection molding tool to be temperature-controlled can be set up by the operator using a sequence formed in this way,
that the temporal course of the temperature is predetermined by the sequential events and/or states as well as the types of temperature changes associated with these events and/or states which occur over the course of time during the injection molding cycle, so that the temporal course of the temperature formed in this manner represents a cycle-synchronous temperature profile,
   an operator can freely and easily program a desired value temperature profile, without having to access or interfere with the PLC. The operator must only select the desired events and/or states as well as the desired types of temperature changes from the available events and/or states as well as from the available types of temperature changes, and associate these with each other. A sequence can be formed, on one hand, from several associated events and/or states and, on the other hand, as types of temperature changes. In other words, a sequence is formed from several such associations. This sequence of associated events/states and types of temperature changes produces a temporal sequence of events and/or states. This is accompanied by a temporal sequence of types of temperature changes, corresponding to the association with the selected certain events and/or states performed by the operator. As a result, a time dependence of the temperature is obtained from the sequential events and/or states during the injection molding cycle, and the obtained time dependence of the temperature forms the temperature profile that is freely programmed or adjusted by the operator. When the control device follows this temperature profile, one or several temperature control devices are controlled when the events and/or states occur and operated in a way commensurate with the temperature profile.

An operator can therefore easily set up or freely program a desired temperature profile which does not adhere to exact fixed absolute times, but instead follows cycle-synchronous the events and/or states that occur during an injection molding cycle. It is therefore unimportant during the operation of the injection molding machine at which time these events and/or states occur, i.e., any time delays caused by interfering events do not negatively affect the desired value temperature profile to be followed.

In addition, certain desired temperature values to be approached by the temperature control device may be associated with the start conditions. The temperature control device is operated in a manner so that the temperature in the region to be temperature-controlled changed towards the desired temperature value predetermined for this region. If the desired temperature values cannot be reached or not be reached reliably commensurate with the time dependence of the desired temperature profile during the operation of the injection molding machine, then the temperature control device may be reconfigured or a different temperature control device may be employed. The operator may also change “his/her” desired temperature profile and adapt the profile to the respective situation defined in particular by the existing injection molding machine, the existing injection molding tool and the temperature control devices connected thereto.

The flexibility of the free programmability of the temperature is enhanced by a possible time-delayed control of the temperature control device. An operator may simply define times defining a delay for controlling the temperature control device for a start condition and enter these times in the control device. This means that after an event and/or state occurs, the entered time should elapse commensurate with the formed desired temperature profile before the temperature control device is controlled.

As needed, different types of temperature changes can be or are stored in the control device.

The following exemplary types of temperature changes should be mentioned:
a temperature jump, wherein the temperature control device is operated such that the next desired temperature is reached as rapidly as possible;
a temperature ramp, wherein the temperature control device is operated such that the next desired temperature is to be reached on an ascending (for temperature increase) or descending (for temperature decrease) ramp, wherein the slope of the ramp (ΔT/Δt) can optionally be adjusted;
a “standby” temperature change, wherein the operation of the temperature control device is merely terminated, and the tool temperature is not actively influenced during this time;
no temperature change, wherein the attained or present temperature should be maintained.

Other types of temperature changes are feasible and can optionally be stored in the control device or read in from a data carrier.

The control device preferably includes a control console with a display, with a number of windows provided when a certain program is called, for displaying and entering information. A first window may be provided or opened, in which available events and/states are displayed, and from which the operator can select desired or predefined events and/or states as a start condition for controlling the temperature control device. A second window can be provided or opened, in which the available types of selectable temperature changes are displayed, from which the operator can select desired or defined types of temperature changes and associate these with a start condition. By repeated selection of certain events and/or states, on one hand, and certain types of temperature changes, on the other hand, and their mutual association, a series of associated events/states and types of temperature changes can be formed. In addition, additional windows can be provided for selecting or entering numerical values for one or more additional parameters.

An injection molding machine with a control device according to the invention and with a temperature control device that can be controlled by the control device is particularly suited for the production of molded plastic parts by the aforementioned vario-thermal temperature control of injection molding tools. Advantageously, depending on the plastic molded parts, several regions that can be annealed independent from each other may be arranged in the injection molding tools for manufacturing this plastic molded part. Accordingly, different desired temperature values, in particular different desired temperature profiles, may be set up for these different regions of an injection molding tool. To this end, a number of selectable regions to be temperature-controlled may be stored in the control device for selection by an operator. For each of these regions, an associated desired temperature profile may be freely programmed by a user or operator of the injection molding machine. Advantageously, a dedicated temperature control device for separate temperature control of each region and thus for each temperature channel of the control device may be provided. Depending on the design of a temperature control system, several temperature control devices may be “combined” or housed together in a single temperature control system.

The invention will now be described in more detail with reference to an exemplary embodiment. The injection molding machine may be any type of conventional injection molding machine with a plasticizing and injection unit and with a closure unit with one or several injection molding tools. The control device of the injection molding machine has a program for setting up and following a desired temperature profile.

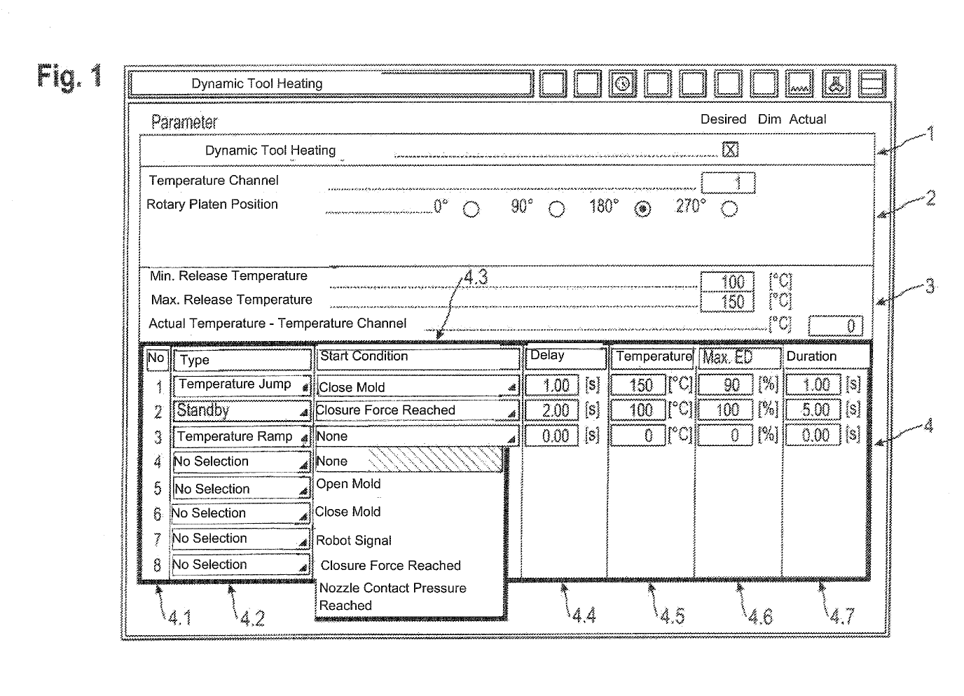

FIG. 1 shows a detail of a display screen of the control device when invoking subprogram “Dynamic Mold Heating.” In a first window 1, an operator can switch the functionality “Dynamic Mold Heating” on or off by checking or unchecking the sole box.

In a window 2, the temperature channel to which the following temperature values to be entered and the later desired temperature profile should relate can be selected. A temperature channel may be associated with, for example, a certain zone in an injection molding tool. For example, a first temperature channel may be provided for the one mold half and a second temperature channel may be provided for the other mold half so that the temperatures for the two mold halves of the injection molding tool can be adjusted to be different and independent from each other. However, two temperature channels may also be provided in a single mold half, for example, if different zones are to have different temperatures. The temperature channel may be, for example, a channel in a certain region of the injection molding tool through which a liquid heat transfer medium flows. However, different types of temperature controls for the zone or region and thus for this temperature channel may be contemplated, for example with an electric resistance heater, an infrared radiator, a Peltier heater or other temperature control means. In the present example, this is the temperature channel 1. One or several temperature control devices may also be provided, wherein preferably a dedicated temperature control is provided for each temperature channel. In practical applications, this may only be a single temperature controller, as long as the controller is capable of controlling the temperature of different temperature channels independent from each other.

Furthermore, different adjustment possibilities may be provided depending on the type of the injection molding tool. When using injection molding tools for a multi-component injection molding process employing a so-called rotary platen technique, the position of, for example, the rotary platen where the mold temperature should be dynamically controlled may predetermined, in the present example in the position 180°.

In another window 3, a display screen for the actual value in the selected temperature channel is provided as well as the option to enter a minimum and a maximum release temperature. The release temperature refers to the temperature which must be reached before the next injection molding process can start, i.e., before this start is “released.” In the present example, the temperature in the temperature channel 1 must therefore have a value between 100° C. and 150° C. before the start for injection can be released. In practical applications, an actual value between 100° C. and 150° C. would be displayed during standard operation of the injection molding machine as “Actual Temperature—Temperature Channel” shortly before the injection. Conversely, if a temperature value outside this range were measured and indicated in the temperature channel 1, then the start for the injection would not yet be released. The minimum and maximum release temperatures depend, inter alia, on the plastic material to be processed. Preferred processing temperatures for each plastic material are specified by the manufacturer of the plastic material.

The window 4 at the bottom in the FIG. is composed of several windows or columns 4.1 to 4.7, the significance of which will now be described:

### Column 4.1

The column 4.1 shows the running number “No.” which is associated with a specific segment of an injection molding cycle. Depending on the injection molding cycle, the entire injection molding cycle may be subdivided more or less finely into individual consecutively numbered segments. For example, in the present example, an injection molding cycle may be divided into eight segments.

### Column 4.2

In column 4.2, the operator can select a certain type for each consecutive number of the available types of temperature changes and thus specify a certain type of temperature change for this number. To this end, different types for a temperature change are stored in the controller of the injection molding machine and can be read into the controller from a data carrier and stored. The stored types of temperature changes represent a selection which are available to the operator during the free programming of the desired temperature profile and from which the operator can select the presently desired or specified type. In the present example, three types of temperature changes are available to the operator for a change in temperature, which are listed in the rows No. 1 to No. 3, namely a temperature jump, a standby and a temperature ramp. However, other types of changes in temperature for a temperature change are also feasible.

### Column 4.3

In this column, the operator can select for each running number a certain start condition from predetermined or predeterminable start conditions. For this purpose, several events and/or states specific for the injection molding cycle and occurring during the injection molding cycle are stored or storable in the control device. The stored events and/or states are available to the operator for selection. These may, for example, include the specific events and states occurring during the injection molding cycle listed below, from which the operator can make a selection:

Selectable Events:
“Close Mold” is the event starting with the closure of the mold;
“Open Mold” is the event starting with opening the mold;
“Robot Signal” is the event that a signal is transmitted from a robot to the injection molding machine (e.g., with the positioning of an insert or for heating an insert with an infrared radiator).

Selectable States:
“Closure Force Reached” is a state where a predetermined closure force has actually been reached;
“Nozzle Contact Pressure Reached” is a state where a predetermined nozzle contact pressure has been reached.

### Column 4.4

This allows for a time-delayed control of the temperature control. In other words, the temperature change according to the associated type of change in temperature is not immediately started when the start condition occurs, but instead with a predetermined time delay. The operator can enter, for example, that a temperature change should start only after a certain time following the start of the mold closure, i.e., a predetermined time after the occurrence of the event “Close Mold.” In the present example, this delay time is 1 second. Moreover, as in the present example, it would be possible to wait for a certain time after the event “Closure Force Reached”—in the present example 2 seconds—until the temperature changes to 100° C. commensurate with the type “Standby”. The type “Standby” is characterized in that the temperature control is simply switched off, for example by turning the control device for temperature control off, and a cooldown to the desired temperature of 100° C. is achieved by simply dissipating the existing heat into the environment. When using a temperature control device with a liquid heat transfer medium, the flow of the heat transfer medium could be stopped, for example. The temperature control is activated again and the control device is again turned on only when the predetermined temperature of presently 100° C. has been reached. When using a temperature control device with a liquid heat transfer medium, the flow of the heat transfer medium and control of the desired temperature could then again be started.

### Column 4.5

In this column, those temperatures can be entered which should be reached at the temperature change according to the running number in column 4.1. These temperatures are therefore desired temperature values which produce the desired temperature curve in a cycle.

### Column 4.6

In this column, an upper limit can be assigned to the time-on duration ED of the control path computed by the temperature controller of the control device. The heating power in this phase can thereby be limited to a desired maximum.

### Column 4.7

The operator has here the option to limit the time for the respective segment (i.e., the number from column 4.1) of the injection molding cycle. A cycle segment is terminated if either the desired temperature in column 4.5 has been reached or if the next start condition in 4.3, i.e. the next event or the next state, has been reached. A premature termination may also occur when a preselected time duration entered in column 4.7 has been reached. The last criterion is advantageous in particular at the end of an injection molding cycle if the present desired temperature is not to be maintained until the next start condition occurs, but if instead, for example, the temperature control device is to be turned off and a switchover to a supervisory control circuit for a standard operating temperature is to occur. This can also be beneficial in the event of a fault.

Overall, in the present example, a sequence of eight associated events and/or states, on one hand, and types of temperature changes, on the other hand, can be displayed. Accordingly, eight pairs of events/states and types of temperature changes can be formed by an operator. Depending on the programming of the control device, more or less such associated pairs of events, states and types of temperature changes may be formed.

Instead of one or more of the aforedescribed windows, suitable regions within a single window may also be provided to display data and/or to enter data. Likewise, separate display screen pages may be used for displaying and/or entering data. Display screen pages may be used as replacement for windows and/or regions; these can also be combined with windows and/or regions. The desired visualization for displaying and/or entering data depends on the respective circumstances and is not a limitation of the invention.

The following process flow is therefore obtained for the example illustrated in FIG. 1 (at least for part of an injection molding cycle):
1 At the beginning of the mold closure, a time counter is started and a temperature jump is started after 1 second in order to heat the tool or the selected temperature channel as quickly as possible from the present temperature to a desired temperature of 150° C. The temperature control device is controlled and operated in a manner so that a temperature of 150° C. in the mold in the zone with the temperature channel 1 is reached within the shortest possible time. The temperature in the proximity of the tool wall can be measured with suitable temperature sensors and supplied to a control device.
2 When the tool is closed and the closure force is built up, it is monitored when a predetermined closure force is reached. As soon as this state has been reached, the temperature control switches to Standby with a delay of 2 seconds, wherein the desired temperature value is 100° C. and the maximum ED value is limited to 100%. As described above, the temperature control is stopped, with a waiting time until a cooldown to 100° C. has occurred. The temperature control then starts again.

In the same way, the further process flow of the injection molding cycle and the associated parameters for temperature control (type, start condition, delay, . . . ) can be entered, until finally a certain injection molding cycle with a certain desired value temperature profile is completely adjusted.

FIG. 2 shows an exemplary desired value temperature profile, wherein the values indicated in the display screen window of FIG. 1 have been at least partially adopted for the values shown for the segments No. 1 and No. 2 of the injection molding cycle. Until a first event occurs and until the segment No. 1 of the injection molding cycle begins, a standard operating temperature of 80° C. is predetermined and controlled by a supervisory control circuit. As soon as the event “Close Mold” has occurred and 1 second has elapsed, the temperature control device TE is controlled (see the arrows at the bottom of FIG. 2) in such a way that the temperature of 150° C. indicated in column 4.5 is attained with a temperature jump. After the mold is closed, the closure force is built up and the segment No. 2 of the injection molding cycle begins as soon as a predetermined closure force is reached. The temperature control device TE is controlled 2 seconds after the state “Closure Force Reached” by switching over to standby, as described above. The start of the injection begins a short time thereafter, and the segment No. 3 begins at the end of the injection, i.e., the event “End Injection” is the start condition for controlling the temperature control device TE so that a cooldown to 60° C. occurs with a temperature ramp. The section No. 4 starts with the event “Open Mold.” This event transmits a control signal to the temperature control device to heat the mold again, this time to a temperature of 120° C. It will be assumed that a duration of 4 seconds has been entered in column 4.7 for this event No. 4. This indicates the following. If a subsequent event (e.g., “Robot Signal” or “Close Mold”) or state has not been reached after this time, for example due to a fault, then the process switches back to the supervisory temperature control circuit and the standard operating temperature of presently 80° C. is approached. The temperature increase is thus terminated (see the hatched region of the temperature curve). After the duration in column 4.7 has elapsed, the dynamic mold heating is then temporarily switched off until the next event or the next state—i.e., the next start condition—is reached. This may be, for example, the beginning of the next cycle and may start with the event “Close Mold.”

The user is thus able to set up, i.e. to program and optionally optimize “his/her” desired value temperature profile without programming knowledge. By defining the start conditions by the events and/or states that occur during the injection molding cycle, deviations that occur during the operation are automatically “transferred” to the temperature profile, i.e., it is for example unimportant that the state “Closure Force Reached” is always reached at the same time or if this time is subject to variations.

It can be ensured by suitable measures that unworkable or detrimental parameters cannot be entered into the controller. For example, only temperature values within predetermined limits may be entered and temperature values outside these limits would not be accepted by the program. In addition, a monitoring mechanism could be provided which intervenes and makes corrections when the predetermined desired temperature values during an injection molding cycle are still absent when the next start condition is reached. In the simplest situation, the injection molding machine would simply wait and stop the injection molding cycle.

Which temperature is monitored, i.e., measured, and is entered into the control circuit for the desired temperature value entered in column 4.5 as a controlled valuable depends on the particular circumstances. For example, this could be a temperature in the tool wall in the proximity of the cavity surface. However, it could also be a temperature of a heat transfer medium at a certain location in the temperature control loop of the liquid temperature control medium.

1.-15. (canceled)

16. A control device for an injection molding machine, said control device configured to:
store several events and/or states which are specific for an injection molding cycle and which occur during an injection molding cycle,
store several types of temperature changes,
provide the stored events and/or states as one or more start conditions for controlling one or more temperature control devices for temperature control of an injection molding tool,
enable an operator to select events and/or states from the stored events and/or states,
enable the operator to select types of temperature changes from the stored types of temperature changes,
enable the operator to associate certain types of temperature changes with one another,
form a sequence of several events and/or states and types of temperature changes, and
enable the operator to set up a temporal course of a temperature in a region of an injection molding tool to be temperature-controlled using the formed sequence,
wherein the temporal course of the temperature is predetermined by the sequence of events and/or states as well as the types of temperature changes associated with these events and/or states which occur over a course of time during the injection molding cycle, so that the temporal course of the temperature formed in this manner represents a cycle-synchronous temperature profile.

17. The control device of claim 16, wherein a desired temperature value is associated with the one or more start conditions and the control device controls a temperature control device when the one or more start conditions occur and operates the temperature control device such that a temperature in a region to be temperature-controlled is changed in the direction of the desired temperature value predetermined for this region.

18. The control device of claim 17, wherein a time-delay associated with each selected event and/or selected state is entered into the control device, and wherein the temperature control device is controlled after the time delay following the selected event and/or state has elapsed.

19. The control device of claim 17, wherein the types of temperature changes selected by the operator are selected from the group consisting of:
a temperature jump, wherein the temperature control device is operated such that the next desired temperature is reached as rapidly as possible;
a temperature ramp, wherein the temperature control device is operated such that the next desired temperature is to be reached on an ascending (for temperature increase) or descending (for temperature decrease) ramp,
a “standby” temperature change, wherein the operation of the temperature control device is merely terminated and the tool temperature is not actively controlled; and
no temperature change, wherein the attained or present temperature is maintained.

20. The control device of claim 17, comprising an operator console and a display screen, wherein the display screen comprises a first window or a first region displaying the events and/or states for selection by the operator as the one or more start conditions for controlling the temperature control device, and a second window or a second region displaying the types of temperature changes selected by the operator and associated with the one or more start conditions.

21. The control device of claim 20, wherein the display screen comprises additional windows or regions for selection or input of numerical values for one or more of the parameters selected from the group consisting of:
time for delayed control of the temperature control device
desired temperature value,
maximum on-time in percent, and
duration of the on-time.

22. An injection molding machine comprising the control device of claim 16.

23. The injection molding machine of claim 22, comprising at least one temperature control device controlled by the control device.

24. The injection molding machine of claim 23, comprising one or more injection molding tools to be temperature-controlled by the at least one temperature control device, said one or more injection molding tools having predetermined regions which are stored in the control device, with the control device enabling the operator to select one or more of the predetermined regions.

25. The injection molding machine of claim 24, wherein different desired temperature values are associated with different predetermined regions of the one or more injection molding tools.

26. The injection molding machine of claim 25, wherein the different desired values comprise temperature profiles.

27. A method for forming a desired value temperature profile in a control device, comprising the steps of:
storing in the control device several events and/or states as well as several types of temperature changes which are specific for an injection molding cycle and which occur during the injection molding cycle and making the stored events and/or states and the types of temperature changes available to an operator for selection,
providing the stored events and/or states as one or more start conditions for controlling one or more temperature control devices for temperature control of regions of an injection molding tool,
enabling an operator to select certain events and/or certain states and certain types of temperature changes and to associate the selected certain events and/or certain states and certain types of temperature changes with one another,
forming a sequence of several such associated events and/or states and types of temperature changes, and
forming from the formed sequence a temporal course of temperature, wherein the temporal course of temperature is predetermined by the events and/or states and the temperature changes associated with these events and/or states that occur over a course of time in the injection molding cycle.

28. The method of claim 27, further comprising the steps of:
associating desired temperature values with the one or more start conditions, and
controlling and operating the one or more temperature control devices, when a start condition occurs, such that a temperature in a region to be temperature-controlled is changed in the direction of a desired temperature value predetermined for this region.

29. The method of claim 27, further comprising the steps of:
entering into the control device a certain delay time for each selected event and/or selected state, and
controlling the one or more temperature control devices with the control device after the delay time has elapsed following the selected event or the state.

30. The method of claim 27, further comprising the steps of:
selecting one or more temperature channels from available temperature channels, and
setting up a desired value temperature profile for each selected temperature channel.

31. The method of claim 30, wherein a desired value temperature profile is set up for each of several regions of an injection molding tool to be temperature-controlled.
